(19) United States
(12) Patent Application Publication
(10) Pub. No.: US 2005/0027932 A1
(43) Pub. Date: Feb. 3, 2005

(54) Content addressable memory with redundant stored data

(76) Inventor: Larry J. Thayer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/632,757

(22) Filed: Jul. 31, 2003

(51) Int. Cl. G06F 12/00

(52) U.S. Cl. 711/108

(57) ABSTRACT

In a first example content addressable memory (CAM) system, an input bit pattern is compared to a plurality of identical stored bit patterns. The CAM system generates a hit signal when a match is found for at least one of the identical stored bit patterns. As a result, the system generates a false miss signal only if false matches result for all the identical stored bit patterns. In alternative examples, the system output generates a hit signal when at least half of the identical stored bit patterns match the input bit patterns, or alternatively when a majority of the identical stored bit patterns match the input bit patterns.

### FIELD OF INVENTION

This invention relates generally to computer memory systems.

### BACKGROUND

A content addressable memory (CAM) compares stored bit patterns to an input bit pattern. Typically, for each stored bit pattern, a CAM provides an output signal (hit signal) that indicates whether the stored bit pattern matches the input bit pattern. If any one of the stored bits changes, even temporarily, the comparison may fail, and the CAM may fail to assert a “hit” signal (false “miss”). Bits can change, for example, as a result of alpha particles emitted from packaging materials, cosmic rays, power supply noise, signal line noise, or electromagnetic fields. CAM's are commonly used in memory systems in areas in which a false miss may cause corrupted data. Accordingly, reducing the probability of a false miss is important for computer reliability and data integrity. The probability of changed bits can be reduced by including error correction codes (ECC) with the bits, and periodically checking the contents for errors (and correcting errors if necessary). The probability of changed bits can be also reduced by improved package shielding and signal line conditioning. However, nothing is 100% effective, and there is a need for further reduction of the probability of a false miss.

### SUMMARY

In a CAM system, an input bit pattern is compared to a plurality of identical stored bit patterns. The CAM system generates a hit signal when a match is found for at least one of the identical stored bit patterns. In alternative examples, the system generates a hit signal when a match is found for at least half of the identical stored bit patterns, or alternatively when a match is found for a majority of the identical stored bit patterns.

### BRIEF DESCRIPTION OF THE DRAWINGS

FIG. 1 is a block diagram of an example computer system.

FIG. 2 is a block diagram illustrating an example of a cache memory.

FIG. 3 is a block diagram illustrating an example embodiment of a CAM system.

FIG. 4 is a block diagram of an alternative example embodiment of a CAM system.

FIG. 5 is a block diagram of another alternative example embodiment of a CAM system.

FIG. 6 is a flow chart of an example method.

### DETAILED DESCRIPTION

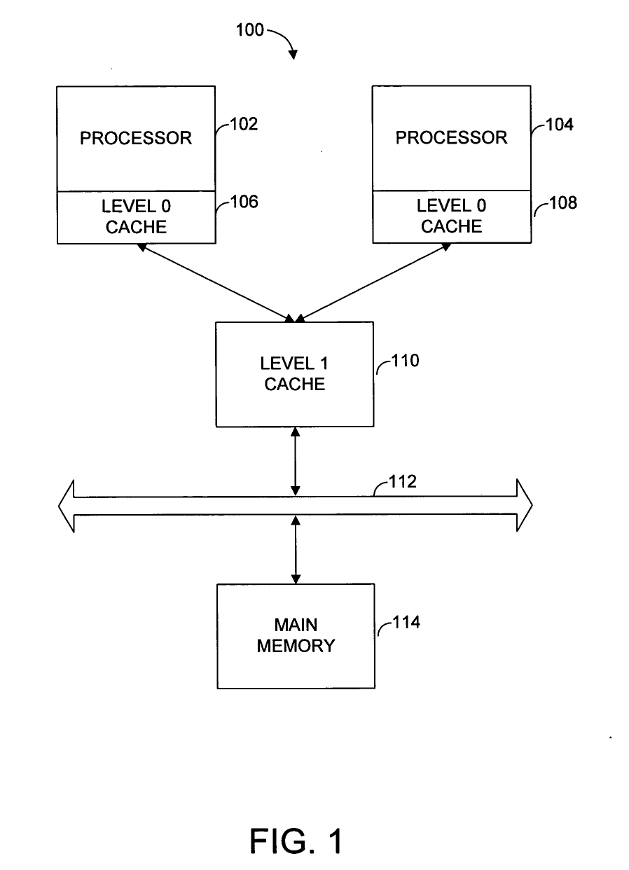

FIG. 1 depicts an example computer system 100, which will be used to illustrate one example of where a CAM may be used, and will be used to illustrate one way in which a false miss from a CAM can result in corrupted data. The computer system has two processors (102, 104). Each processor includes an integrated cache (106, 108). The processors share an external cache 110. The system includes a main memory 114. When data is requested, for example, by processor 102, the system first checks to see if the requested data is in the integrated cache 106. If the requested data is not in the integrated cache 106, the system checks to see if the requested data is in the external cache 110. If the requested data is not in either cache, then the requested data is retrieved from main memory 114.

When one of the processors modifies data, the modified data is typically temporarily saved in at least one of the cache memories before being written to main memory. If a processor requests the modified data, part of the address for the data is sent to a CAM associated with a cache to see if the data is present in the cache. If the CAM asserts a signal indicating that the data item is not present, when it actually is present (a false miss), then the requesting processor may receive data from main memory that is different than the modified data in the cache. Accordingly, if a CAM associated with a cache asserts a false miss signal, it is possible that data may be corrupted. This is just one example, and in general, CAM's may be used in multiple ways in computer memory systems where a false miss can result in corrupted data.

The system of FIG. 1 is intended to be a non-limiting example of a system that includes a CAM. In general, computer systems may have fewer than two processors, or may have more than two processors. Computer systems may have fewer than two cache levels, or may have more than two cache levels.

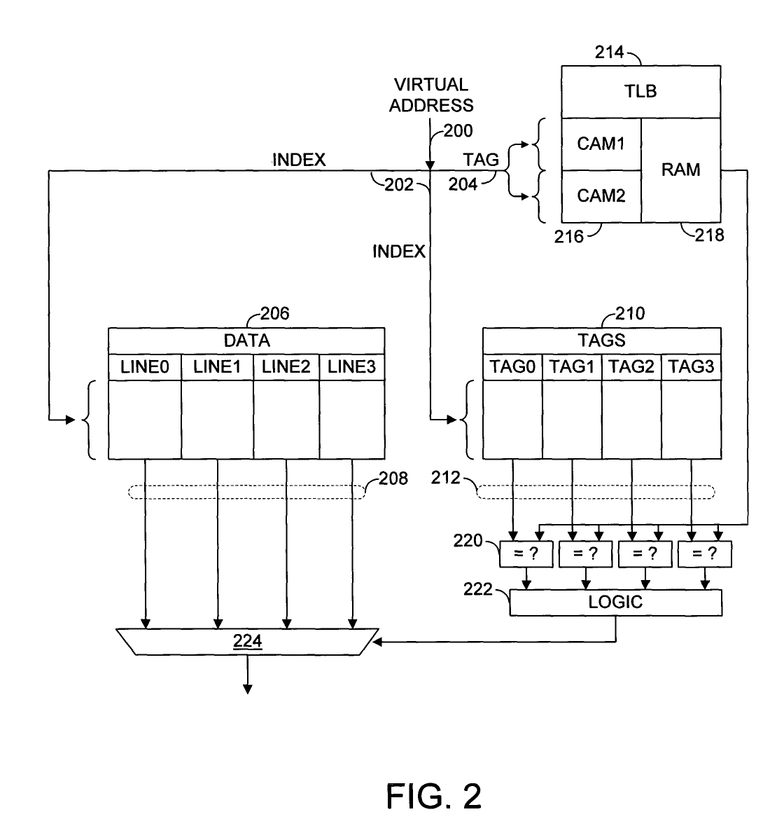

FIG. 2 illustrates additional detail for an example embodiment of a cache memory, which might be used as any of the cache memories (106, 108, 110) in FIG. 1. For the cache memory of FIG. 2, a processor produces virtual addresses that are translated to physical addresses, which access physical main memory. To reduce address translation time, computers commonly use a specialized associative cache dedicated to address translation, commonly called a Translation Look-aside Buffer (TLB). The cache in FIG. 2 receives a virtual address 200, and the cache in FIG. 2 includes a TLB 214.

For large caches, it is common to use a subset of an address (called an index) to designate a line position within the cache, and then store the remaining set of more significant bits of each physical address (called a tag) along with the data. In a cache with indexing, an item with a particular address can be placed only within a set of lines designated by the index. If the index maps to more than one line in the subset, the cache is said to be set-associative. All or part of an address is hashed to provide a set index which partitions the address space into sets. The cache in FIG. 2 is an example of a four-way set-associative cache, which is used for illustration.

In FIG. 2, a virtual address 200 comprises lower order index bits 202 and upper order tag bits 204. The index bits are typically the same for the virtual address and the physical address. The index bits are used to select one set of lines of data in a data section 206 of the cache. The output of data section 206 is four lines of data 208. The index bits are also used to select a set of physical tags in a tag section 210 of the cache. The output of the tag section 210 is four physical tags 212, each corresponding to one line of data. The virtual tag bits 204 are used to select one entry in a CAM system 216 within the TLB 214. The TLB 214 stores both virtual and physical tags. Note that the virtual tag 204 may not find a match in the CAM system 216, in which case there is a TLB miss. Note also that multiple virtual tags may map to one physical tag. For a TLB hit, the CAM system designates an address in TLB RAM 218 for a physical tag corresponding to the virtual tag 204. A physical tag is then retrieved from the TLB RAM 218. Each of four digital comparators 220 then compares the physical tag from the TLB RAM 218 to a physical tag 212 from the tag section 210. A matching pair of physical tags indicates through logic 222 which one of four lines of data is selected by a multiplexer 224. Note that for the particular index bits there may not be a matching pair of physical tags, in which case there is a cache miss.

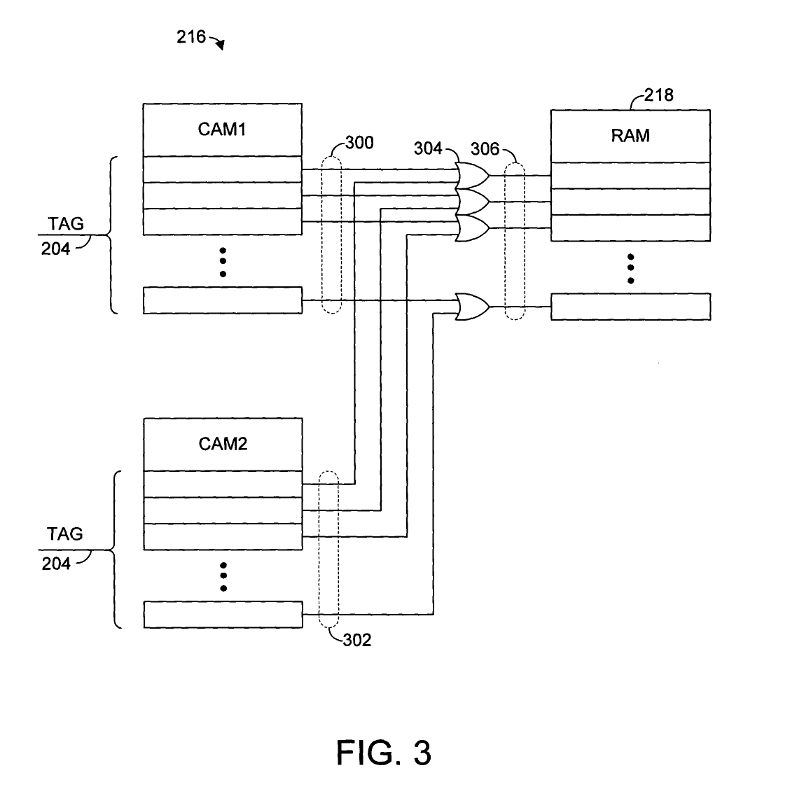

The example CAM system 216 in FIG. 2 comprises two independent CAM's, designated CAM1 and CAM2. More detail is provided in FIG. 3.

In FIG. 3, CAM1 and CAM2 each receive the virtual tag bits 204 as input bits. CAM1 and CAM2 each have an array of rows, each row including storage for virtual tag bits. For each row, a digital comparitor (not illustrated) compares the stored bits to the input bits (204). If the bits match for a row, a hit signal is generated at the row output (300, 302). In FIG. 3, for row outputs 300 and 302, it is assumed that if there is a hit, a logical ONE (or logical TRUE) is generated, and if there is a miss, a logical ZERO (or logical FALSE) is generated. For each row in CAM 1, there is a corresponding row in CAM2 containing identical virtual tag bits. For corresponding rows, the corresponding row outputs are logically OR'ed (304), so that if the stored virtual address in CAM1, or the corresponding stored virtual address in CAM2, matches the input bits 204, then a system hit signal is generated at an output 306 of the CAM system 216. If one of the system outputs 306 is a logical ONE, then a corresponding physical tag is output from a corresponding storage cell in RAM 218.

As long as all the bits for at least one of the corresponding rows in either CAM1 or CAM2 remain valid, then a valid system hit (or miss) signal 306 will be generated by the CAM system. A system miss signal is generated by the CAM system only if both corresponding rows in CAM1 and CAM2 generate a row miss signal.

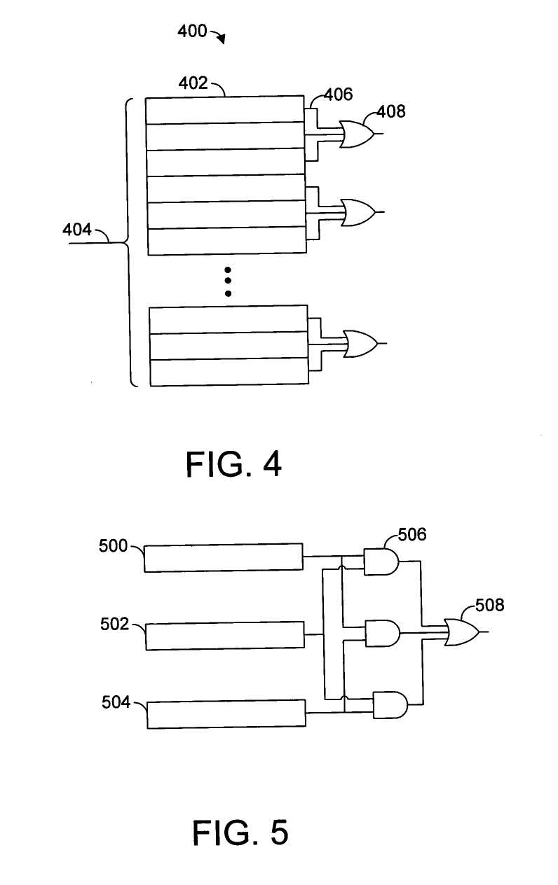

In the example of FIG. 3, a CAM system comprises multiple independent CAM's, with corresponding row outputs logically combined. FIG. 4 illustrates an alternative example. In FIG. 4, a CAM system comprises an array of rows logically grouped into sets of three. Each of the rows 402 receives the input bits 404. Within each row, the input bits 404 are compared to stored bits, and if the bits match then a row hit signal is generated at the row output 406. In the example of FIG. 4, each row in a set of three rows stores identical bits. The three row outputs 406, for a set of rows, are logically OR'ed (408). Within a set of three rows, if at least one of the row outputs 406 is a hit signal, then the CAM system 400 generates a system hit signal. A system miss signal is generated only if all three rows in a set of rows generate a row miss signal. In particular, a false system miss signal is generated only if all three rows in a set of rows generate a false row miss signal.

The examples of systems 3 and 4 may be combined. For example, a CAM system may store four identical copies of stored bits, two in one CAM and two in a second CAM.

Instead of OR'ing the row outputs, they may be logically AND'ed, so that a CAM system hit is generated only if all rows generate a hit. Alternatively, a robust voting system may be implemented, in which a CAM system output signal is determined by at least half (even number or rows) or majority (odd number of rows) of the row outputs for rows storing identical data. FIG. 5 illustrates an example CAM system in which a CAM system hit is generated when at least two rows generate a hit, and a CAM system miss is generated when at least two rows generate a miss. FIG. 5 illustrates three rows (500, 502, 504) of a CAM system, where the rows may be in separate CAM's, all in one CAM, or some combination. Identical data is stored in each of the rows, and input data is compared to the stored data in each of the rows. The row outputs are logically AND'ed (506) in pairs. The outputs of the AND gates are OR'ed (508). As a result, if only one row generates a false row output signal, the system output signal is not affected. That is, the CAM system generates a false hit only if at least two rows generate a false hit, and generates a false miss only if at least two rows generate a false miss.

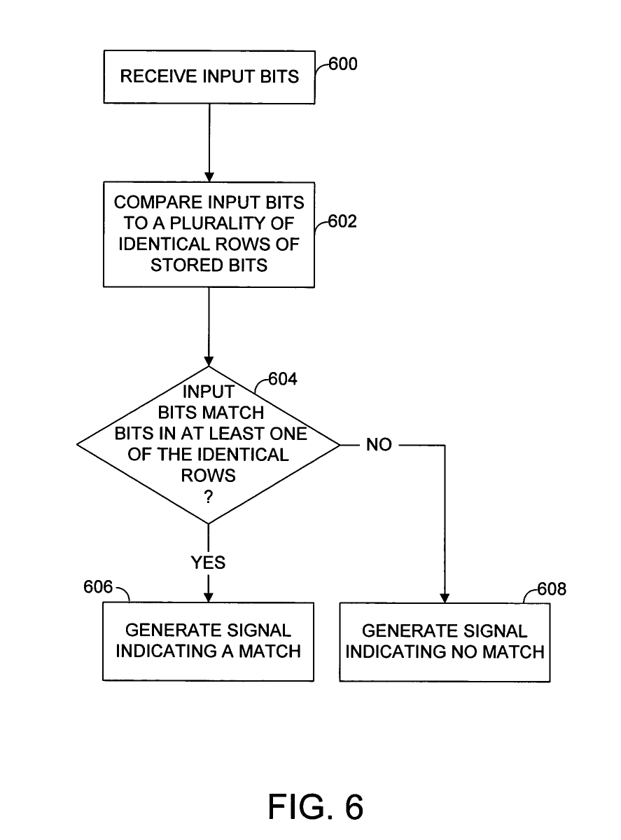

FIG. 6 illustrates an example method to be performed by a content addressable memory. At step 600, input bits are received. At step 602, the input bits are compared to a plurality of identical rows of stored bits. At step 604, if the input bits match stored bits in at least one of the rows of identical stored bits, then at step 606 a signal is generated indicating a match. Otherwise, at step 608 a signal is generated indicating no match.

As discussed above, CAM's are used in more than just TLB's. Storing identical bits in multiple locations, and combining hit outputs from the multiple locations, may be used in any CAM in which additional reliability is desired. In general, in accordance with the invention, identical copies of data to be compared are stored in corresponding rows of each of multiple CAM's, or within all rows of a set of rows, and row outputs may be combined from two or more CAM's, or two or more rows within one CAM, or a combination. Each CAM may have areas that are not redundant. The logic may be inverted so that in the case of a hit a logical ZERO is generated. In that case, in FIGS. 3 and 4, logical NOR gates may be used instead of the logical OR gates for logically combining row outputs.

1. A memory system, comprising:
a plurality of rows, each row receiving identical input bits, each row having identical stored bits, each row generating, at a row output, a row hit signal when its stored bits match the input bits, and the row outputs are logically combined to generate a system hit signal when at least one of the rows generates a row hit signal.

2. The memory system of claim 1, where each row in the plurality of rows is in a different memory.

3. The memory system of claim 1, where at least two of the rows in the plurality of rows are in one memory.

4. The memory system of claim 1, where the system hit signal is a logical OR of the row hit signals.

5. A computer system, comprising:
a cache memory; and
a content addressable memory associated with the cache memory, the content addressable memory receiving input bits, the content addressable memory storing a plurality of copies of at least part of an address for each data item in the cache memory, the content addressable memory generating a signal indicating a match to the input bits when at least one of the plurality of copies of at least part of an address for each data item in the cache memory matches the input bits.

6. A method, comprising:
receiving, by a memory system, input bits;
comparing, by the memory system, the input bits to a plurality of identical sets of stored bits; and
generating a signal indicating a match when at least one of the identical sets of stored bits matches the input bits.

7. A content addressable memory system, comprising:
means for storing a plurality of copies of stored bits;
means for comparing each copy of stored bits to input bits; and
means for generating a system hit signal when at least one the plurality of copies of stored bits matches the input bits.

8. A memory system, comprising:
a plurality of rows, each row receiving identical input bits, each row having identical stored bits, each row generating, at a row output, a signal indicating whether its stored bits match the input bits, and the row outputs are logically combined to generate a system output signal corresponding to at least half of the signals from the row outputs.

9. The memory system of claim 8, where the row outputs are logically combined to generate a system output signal corresponding to a majority of the signals from the row outputs.
